(19) United States
(12) Patent Application Publication
(10) Pub. No.: US 2015/0338987 A1
(43) Pub. Date: Nov. 26, 2015

(54) DISPLAY APPARATUS AND METHOD FOR CONTROLLING DISPLAY APPARATUS

(71) Applicant: NEC DISPLAY SOLUTIONS, LTD., Minato-ku, Tokyo (JP)

(72) Inventor: Hiroyuki KOKATSU, Tokyo (JP)

(73) Assignee: NEC Display Solutions, Ltd.,, Minato-ku, Tokyo (JP)

(21) Appl. No.: 14/655,660

(22) PCT Filed: Dec. 28, 2012
(86) PCT No.: PCT/JP2012/084101

§ 371 Date: Jun. 25, 2015

(51) Int. Cl. G06F 3/041

(52) U.S. Cl. CPC G06F 3/0416

(57) ABSTRACT

A display apparatus constitutes a display system that displays an image using the display apparatus and at least one other display apparatus. The display apparatus includes: a display unit that displays an image; a detection unit that detects a position selected on the display unit by a user to obtain positional information; a communication unit that communicates with a control apparatus and with the at least one apparatus; and a control unit that performs control to communicate with the control apparatus and to communicate with the at least one display apparatus, via the communication unit. The control unit outputs the positional information and identification information of the display apparatus in the display system, via the communication unit when the user selects a position on the display unit.

### TECHNICAL FIELD

The present invention relates to a display apparatus and a method for controlling a display apparatus.

### BACKGROUND ART

In recent years, terminals that provide a range of information have been installed for example in public places such as hospitals, art galleries, libraries, tourist sites, train stations and the like, and in commercial facilities. As a terminal that provides a range of information, there is for example an apparatus having a touch panel in which a display unit and a detection unit that detects an operation by a user are combined. In the touch panel, the operation of the user is detected by an infrared system, for example. The touch panel of the infrared system detects a position on the display unit operated by the user by disposing a plurality of light sources that emit infrared rays in the surroundings of the display unit, and detecting the position on the display unit intercepted by a finger or the like of the user (for example, refer to Patent Document 1).

A terminal installed in such a public place or a commercial facility is required to have a large screen that can provide a lot of information. For a terminal having such a large screen, there is for example a terminal in which a touch panel is incorporated in a liquid crystal display with a large screen. Furthermore, for a terminal having a large screen, there is a terminal in which an input unit having a plurality of infrared sensors on the whole surface of a large screen liquid crystal display is installed in order to utilize it as a touch panel.

### PRIOR ART DOCUMENT

### Patent Document

[Patent Document 1] Republished Japanese Translation No. 2009/119769 of the PCT International Publication for Patent Applications

### SUMMARY OF THE INVENTION

### Problem to be Solved by the Invention

In a technique disclosed in Patent Document 1, a large screen requires a large touch panel. Since the productivity of such a large touch panel is low, it is difficult to reduce the cost of a terminal for providing information.

The present invention has been made in consideration of the above problem, with an exemplary object of providing a position correction apparatus, a display apparatus, and a method for controlling the display apparatus, which can reduce the cost of an information terminal having a large touch panel corresponding to a large screen.

### Means for Solving the Problem

In order to achieve the above object, a display apparatus according an exemplary aspect of the present invention constitutes a display system that displays an image using a plurality of display apparatuses, and includes: a display unit that displays an image; a detection unit that detects a position selected on the display unit by a user; a communication unit that communicates with a control apparatus and with at least one apparatus among other display apparatuses constituting the display system; and a control unit that performs control to communicate with the control apparatus and to communicate with the at least one apparatus among other display apparatuses, via the communication unit, the control unit outputting positional information detected by the detection unit and own-identification information in the display system, via the communication unit when the user selects a position on the display unit.

In order to achieve the above object, a display apparatus according to an exemplary aspect of the present invention includes: a control unit which, based on at least information regarding a location in a display system that displays an image using a plurality of display apparatuses, which is at least information regarding a location of a display apparatus detected a position selected on a display unit by a user, and a resolution of the display apparatus, corrects the position detected by the display apparatus to a position with respect to the image displayed on the whole display system.

In order to achieve the above object, a display apparatus according to an exemplary aspect of the present invention includes: a control unit which, based on information regarding a location in a display system that displays an image using a plurality of display apparatuses, which is at least information regarding a location of another display apparatus that detected a position selected on a display unit by a user, and a resolution of the own display apparatus, corrects the position detected by the other display apparatus to a position with respect to the image displayed on the whole display system.

In order to achieve the above object, a method for controlling a display apparatus according to an exemplary aspect of the present invention includes: a step of correcting, based on information regarding a location in a display system that displays an image using a plurality of display apparatuses, which is at least information regarding a location of a display apparatus that detected a position selected on a display unit by a user, and a resolution of the display apparatus, the position detected by the display apparatus to a position with respect to the image displayed on the whole display system.

In order to achieve the above object, a method for controlling a display apparatus according an exemplary aspect of the present invention includes: a step of correcting, based on information regarding a location in a display system that displays an image using a plurality of display apparatuses, which is at least information regarding a location of another display apparatus that detected a position selected on a display unit by a user, and a resolution of the own display apparatus, the position detected by the other display apparatus to a position with respect to the image displayed on the whole display system.

### Effect of the Invention

The present invention corrects, based on at least information regarding the location of a display apparatus that detected a position selected on a display unit by a user, and the resolution of the display apparatus, the position detected by the display apparatus. By so doing, in a case where a plurality of display apparatuses are connected, each of the plurality of display apparatuses having a touch panel can be considered as a display apparatus having a touch panel corresponding to one large screen, and a position selected by a user can be detected. As a result, the present invention can reduce the cost of an information terminal having a large touch panel corresponding to a large screen.

### BRIEF DESCRIPTION OF THE DRAWINGS

FIG. 1 is a schematic block diagram of an image display system according to a first exemplary embodiment.

FIG. 2 is a diagram for explaining a selected position according to the first exemplary embodiment.

FIG. 3 is a diagram for explaining an example of correction values stored in a control apparatus according to the first exemplary embodiment.

FIG. 4 is a diagram for explaining an example of the arrangement of display apparatuses according to a second exemplary embodiment.

FIG. 5 is a diagram for explaining an image supplied to an image display system according to the second exemplary embodiment.

FIG. 6 is a schematic block diagram showing an example of the structure of the image display system according to the second exemplary embodiment.

FIG. 7 is a diagram for explaining reference points and a position selected by a user according to the second exemplary embodiment.

FIG. 8 is a diagram for explaining reference points stored in a storage unit according to the second exemplary embodiment.

FIG. 9 is a diagram for explaining the flow of positional information according to the second exemplary embodiment.

FIG. 10 is a diagram for explaining an example of positional information correction values in a control unit of each display apparatus according to the second exemplary embodiment.

FIG. 11 is a flow chart of a procedure of the determination of a reference position, and positional information correction, performed by the control unit of each display apparatus according to the second exemplary embodiment.

FIG. 12 is a diagram showing a table of reference points stored in a storage unit according to the second exemplary embodiment.

FIG. 13 is a diagram for explaining an example of the arrangement of display apparatuses according to a third exemplary embodiment.

FIG. 14 is a diagram for explaining an image supplied to an image display system according to the third exemplary embodiment.

FIG. 15 is a schematic block diagram showing an example of the structure of the image display system according to the third exemplary embodiment.

FIG. 16 is a diagram for explaining an example of information stored in a storage unit according to the third exemplary embodiment.

FIG. 17 is a diagram for explaining a position selected by a user according to the third exemplary embodiment.

FIG. 18 is a diagram for explaining the flow of positional information according to the third exemplary embodiment.

FIG. 19 is a flow chart of a procedure of the determination of a reference position, and positional information correction, performed by a control unit of each display apparatus according to the third exemplary embodiment.

### EMBODIMENTS FOR CARRYING OUT THE INVENTION

First, an outline of the present invention will be described.

In a display apparatus of the present invention, a reference point is provided on the display apparatus, and the display apparatus corrects and outputs a position selected by a user based on the reference point. In this manner, in a case where a display apparatus with a large screen is formed by arranging a plurality of display apparatuses in rows, it is possible to detect the position on the screen including the combination of the plurality of display apparatuses. As a result, it is possible to reduce the cost of an information terminal having a large screen.

### First Exemplary Embodiment

Hereunder is a detailed description of the present exemplary embodiment using the drawings.

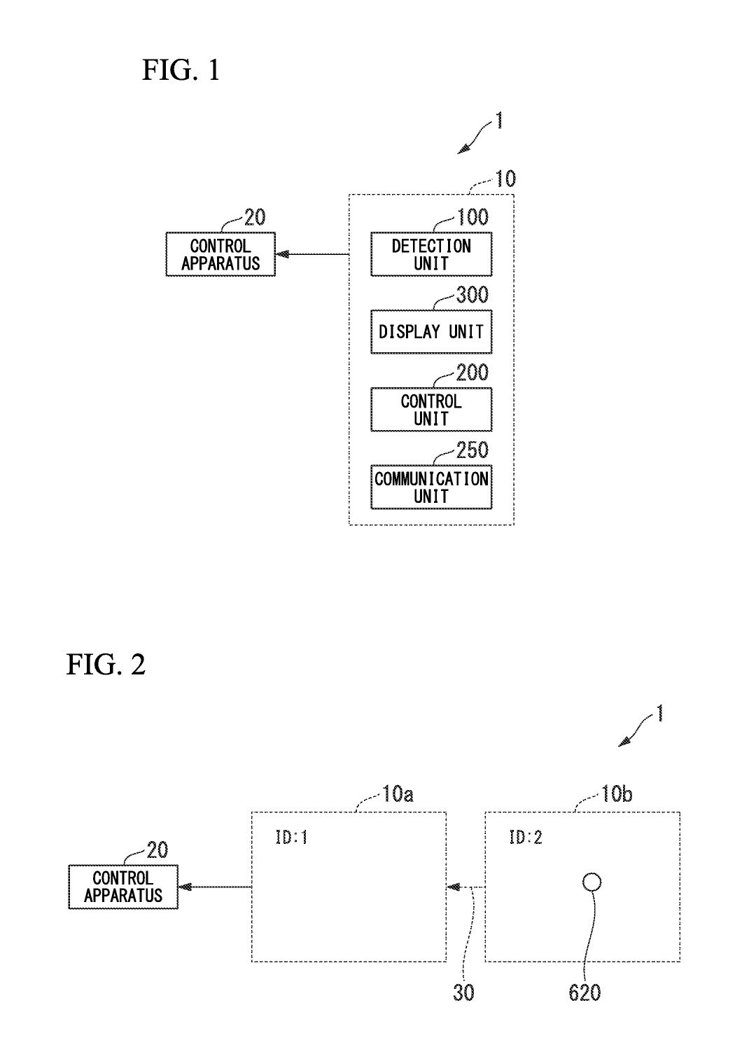

FIG. 1 is a schematic block diagram of an image display system 1 according to the present exemplary embodiment. As shown in FIG. 1, the image display system 1 includes a control apparatus 20. A display apparatus 10 is connected to the control apparatus 20 via a cable, for example. The display apparatus 10 includes a detection unit 100, a control unit 200, a communication unit 250, and a display unit 300.

The detection unit 100 of the display apparatus 10 detects a position operated by a user on the display unit 300. The detection unit 100 is constituted by for example a plurality of infrared sensors. The detection unit 100 may be for example a sensor such as a resistive film type, a capacitive type, a surface acoustic type, or the like. Moreover, the arrangement may be such that the detection unit 100 detects a position operated by a user's finger or an operation pen. The detection unit 100 outputs the detection position detected to the control unit 200.

The control unit 200 outputs the detection position input from the detection unit 100, the resolution of the display unit 300, and information regarding the arrangement of the display apparatuses 10, to the control apparatus 20 via the communication unit 250. The information regarding the arrangement of the display apparatus 10 is information of the position at which the display apparatus 10 that detected the position operated by a user among a plurality of display apparatuses 10 arranged in a matrix, is located. The control unit 200 instructs the display unit 300 to display image information input from the outside. The image information is information such as a still picture, an animation or the like.

The communication unit 250 outputs the information input from the control apparatus 20, to the control unit 200. The communication unit 250 outputs the information output from the control unit 200, to the control unit 200.

The display unit 300 displays image information under the control of the control unit 200. The display unit 300 is for example a liquid crystal panel. The display unit 300 is constituted by including a back light apparatus and the like.

The control apparatus 20 corrects the positional information input from the display apparatus 10 using the information regarding the resolution of the display unit 300 and the location of the display apparatus 10. The display apparatus 10 may incorporate the control apparatus 20.

FIG. 2 is a diagram for explaining a selected position according to the present exemplary embodiment. In the example shown in FIG. 2, one image is displayed on two display apparatuses 10a and 10b placed side by side in the horizontal direction. The control apparatus 20 and the display apparatuses 10a and 10b are linked together (daisy chain connection) by a cable 30. The cable 30 includes distribution wires for image signals and a communication circuit. The control apparatus 20 distributes individual video signals with identification information IDs attached, to each of the display apparatuses 10a and 10b. Alternatively, the arrangement may be such that the video signals are identical, and each of the display apparatuses 10a and 10b cuts out a region to be displayed according to its own location. In the example shown in FIG. 2, the control apparatus 20 distributes to the display apparatuses 10a and 10b, a video signal that is displayed on the whole display system when the two display apparatuses 10a and 10b are placed side by side.

The display apparatuses 10a and 10b are each include a detection unit 100, a control unit 200, a communication unit 250, and a display unit 300. As shown in FIG. 2, the identification information ID of the display apparatus 10a is 1, and the identification information ID of the display apparatus 10b is 2. The identification information ID may be determined by each of the control units 200 according to the arrangement of the display apparatuses 10a and 10b selected by the user.

As shown in FIG. 2, in the case where position 620 on the display unit 300 in the display apparatus 10b is selected by the user, the control unit 200 of the display apparatus 10b outputs; the detected positional information, the information regarding the location of the display apparatus 10b, and the identification information ID, to the display apparatus 10a via the communication unit 250.

The control unit 200 of the display apparatus 10a outputs the positional information, the resolution of the own display unit 300, the information regarding the location of the display apparatus 10b, and the identification information ID of the display apparatus 10b input from the control unit 200 of the display apparatus 10b, to the control apparatus 20 via the communication unit 250.

The control unit 200 of the display apparatus 10b may output the detected positional information, the resolution of the own display unit 300, the information regarding the location of the display apparatus 10b, and the identification information ID, directly to the control apparatus 20 with no intermediation of the display apparatus 10a.

The control apparatus 20 corrects the positional information detected by the display apparatus 10b, using the resolution of the display apparatus 10a and the information regarding the location of the display apparatus 10b. The resolution of the display apparatus 10, the information regarding the arrangement of the display apparatuses 10, and correction values for each location of the display apparatus 10, may be stored in the control apparatus 20 in advance. In the case where the resolution of the display apparatus 10, the information regarding the arrangement, and the correction values are stored in the control apparatus 20 in advance, the control unit 200 of the display apparatus 10b does not need to output the resolution of the own display unit 300 and the information regarding its location each time a user selects a position. That is, the display apparatus 10b outputs the information of the position selected by a user and the identification information ID each time the user selects a position.

For example, suppose that the resolution of each of the display units 300 of the display apparatuses 10a and 10b is 1920 pixels in the horizontal direction and 1080 pixels in the vertical direction. Suppose that the position selected by the user is (X, Y). The information regarding the location of the display apparatus 10b is information that indicates that it is located on the right side of the display apparatus 10 with the two placed side by side in the horizontal direction.

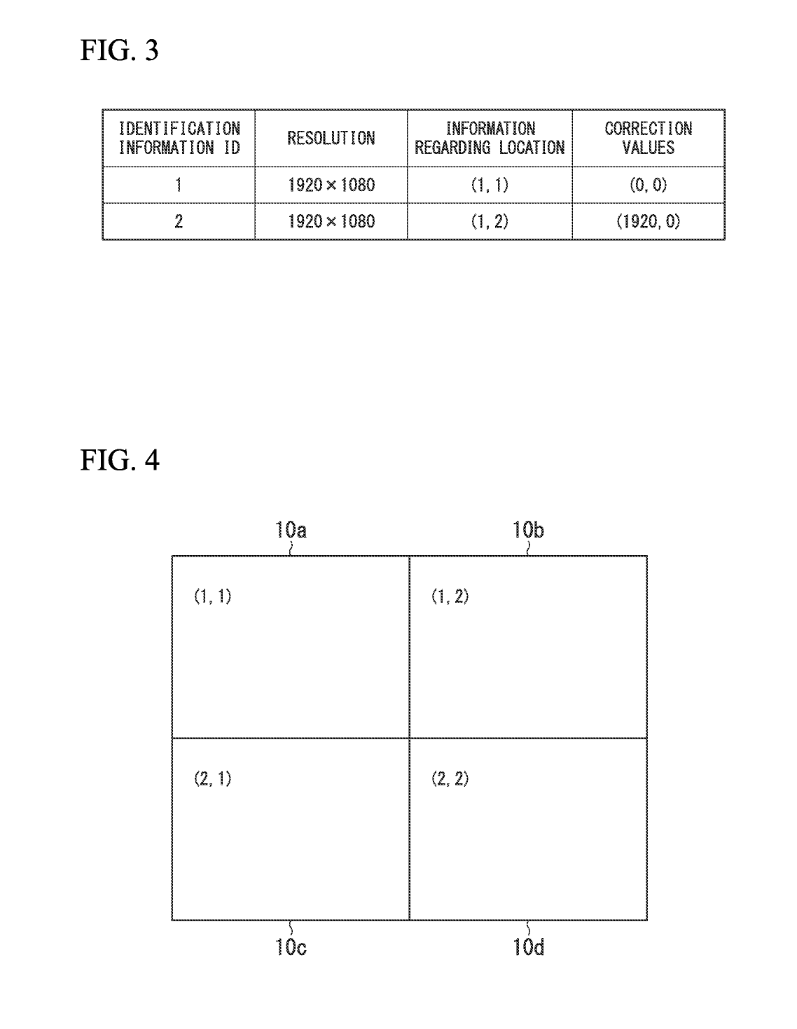

FIG. 3 is a diagram for explaining an example of correction values stored in the control apparatus 20 according to the present exemplary embodiment. As shown in FIG. 3, in the control apparatus 20, identification information IDs, resolutions, information regarding locations, and correction values, are associated and stored. For example, identification information ID=1, resolution 1980 pixels×1080 pixels, location (1, 1), and correction values (0, 0) are associated and stored. Furthermore, identification information ID=2, resolution 1980 pixels×1080 pixels, location (1, 2), and correction values (1920, 0) are associated and stored.

The control apparatus 20 corrects the detected position (X, Y) using the correction values (1920, 0) stored in the own unit associated with the identification information ID=2. In this manner, the control apparatus 20 converts the position selected on the display unit 300 of the display apparatus 10b by the user, to the position (X+1920, Y) at the resolution produced by combining the display unit 300 of the display apparatus 10a and the display unit 300 of the display apparatus 10b.

In FIG. 2, an example of two display apparatuses 10 is described. However, this is not a limitation. The display apparatus 10 may include three or more. For example, in the case where four display apparatuses 10 with identification information IDs=1 to 4 are placed with two side by side in the vertical direction and two side by side in the horizontal direction, correction values for each identification information ID are stored in the control apparatus 20. The control apparatus 20 corrects the position detected using the correction values stored thereinside in association with the identification information ID.

As described above, a display apparatus according to the present exemplary embodiment constitutes a display system that displays an image using a plurality of display apparatuses, and includes: a display unit that displays an image; a detection unit that detects a position selected on the display unit by a user; a communication unit that communicates with a control apparatus and with at least one apparatus among other display apparatuses constituting the display system; and a control unit that performs control to communicate with the control apparatus and to communicate with the at least one apparatus among other display apparatuses, via the communication unit, the control unit outputting positional information detected by the detection unit and own-identification information in the display system, via the communication unit when the user selects a position on the display unit.

Using this construction, in the display apparatus 10 of the present exemplary embodiment, in a case where a plurality of display apparatuses 10 is connected, supposing that the plurality of display apparatuses 10 each having a detection unit 100 is a large screen display apparatus having one detection unit, the selected position can be detected. As a result, in the position correction apparatus of the present exemplary embodiment, it is possible to reduce the cost of an information terminal having a large touch panel corresponding to a large screen.

In the display apparatus 10 of the present exemplary embodiment, the control apparatus 20 can correct a position selected by a user to a position with respect to an image displayed on the whole display system. As a result, the display apparatus 10 of the present exemplary embodiment is only required to output positional information selected by a user, and its own identification information, and can comply with a large screen system having touch panels easily.

### Second Exemplary Embodiment

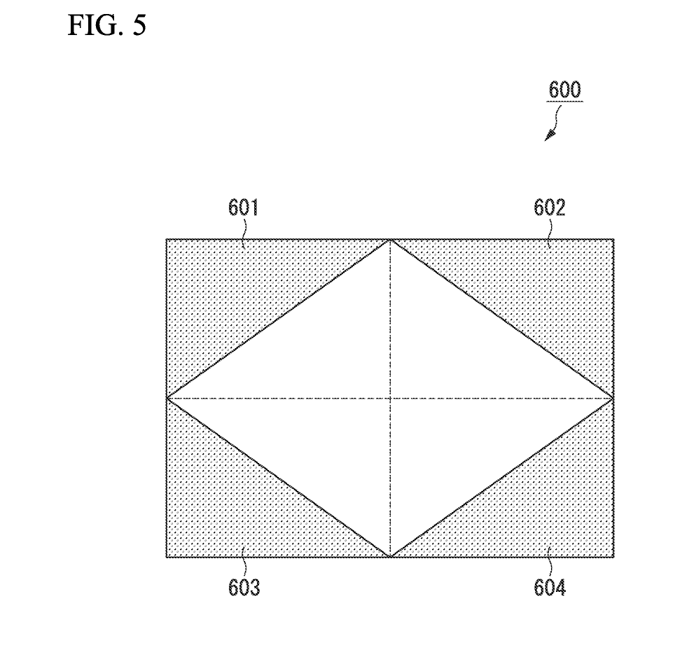

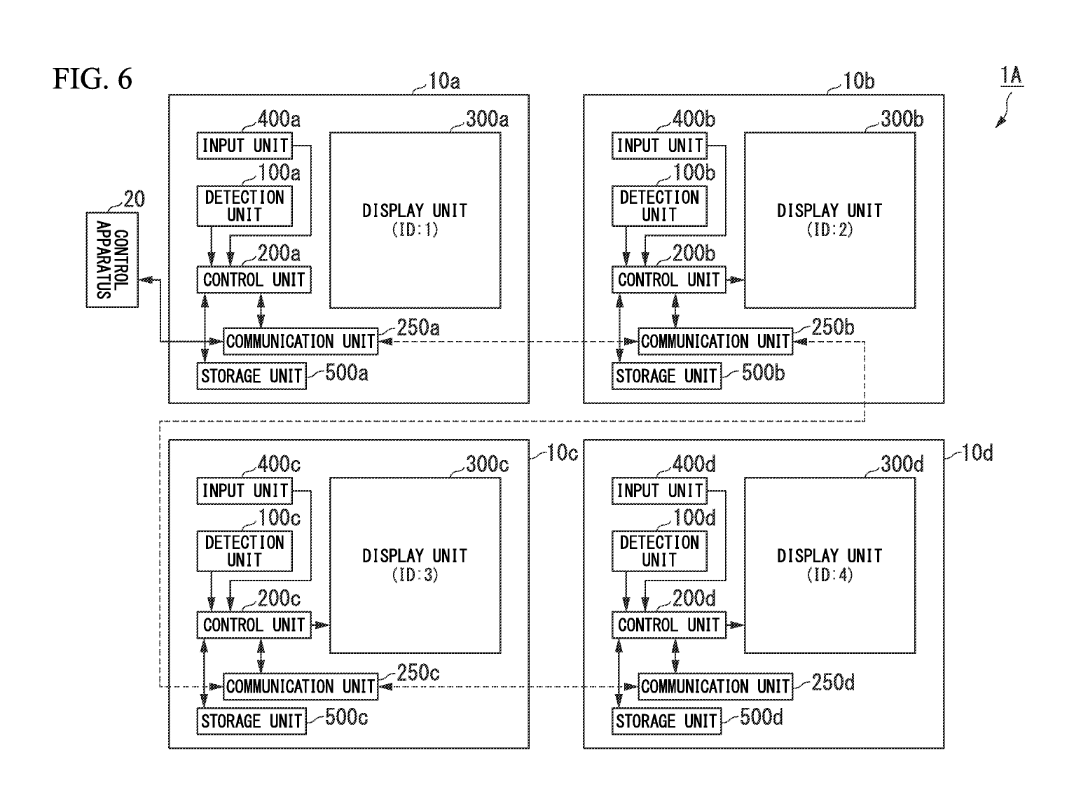

FIG. 4 is a diagram for explaining an example of an arrangement of display apparatuses 10 according to the present exemplary embodiment. FIG. 5 is a diagram for explaining an image supplied to an image display system 1A according to the present exemplary embodiment. FIG. 6 is a schematic structural block diagram showing an example of the structure of the image display system 1A according to the present exemplary embodiment.

In the following description, as shown in FIG. 4, a case will be described in which an image 600 (refer to FIG. 5) is displayed on four display apparatuses 10a to 10d, being placed with two in the vertical direction and two in the horizontal direction. As shown in FIG. 4, the display apparatus 10a is placed at a location (1, 1), and the display apparatus 10b is placed at a location (1, 2). Furthermore, the display apparatus 10c is placed at a location (2, 1), and the display apparatus 10b is placed at a location (2, 2). The image 600 shown in FIG. 5 is supplied to the display apparatuses 10a to 10d. The display apparatus 10a displays an image 601, the display apparatus 10b displays an image 602, the display apparatus 10c displays an image 603, and the display apparatus 10d displays an image 604. In the following description, the display apparatuses 10a to 10d are referred to as display apparatuses 10 as a general term.

For example, in the case where the screen size of each display apparatus 10 is 40 inches, the screen size of the four display apparatuses 10 combined corresponds to 80 inches. Moreover, as shown in FIG. 6, in the image display system 1A, the display apparatuses 10 are linked together by a cable.

As shown in FIG. 6, the image display system 1A includes four display apparatuses 10a to 10d, and a control apparatus 20. Furthermore, the display apparatus 10a includes a detection unit 100a, a control unit 200a, a communication unit 250a, a display unit 300a, an input unit 400a, and a storage unit 500a. The display apparatus 10b includes a detection unit 100b, a control unit 200b, a communication unit 250b, a display unit 300b, an input unit 400b, and a storage unit 500b. The display apparatus 10c includes a detection unit 100c, a control unit 200c, a communication unit 250c, a display unit 300c, an input unit 400c, and a storage unit 500c. The display apparatus 10d includes a detection unit 100d, a control unit 200d, a communication unit 250d, a display unit 300d, an input unit 400d, and a storage unit 500d. Hereunder, the detection units 100a to 100c are referred to as detection units 100 as a general term, and the control units 200a to 200d are referred to as control units 200 as a general term. Moreover, the input units 400a to 400d are referred to as input units 400 as a general term, and the storage units 500a to 500d are referred to as storage units 500 as a general term.

First is a description of the common functions of the display apparatuses 10. The detection unit 100 detects an operation on the display unit 300 by a user, and outputs a first detection signal, being the detected result, to the control unit 200. The detection unit 100 is constituted from for example a plurality of infrared sensors. The detection unit 100 may be for example a sensor such as a resistive film type, a capacitive type, a surface acoustic type, or the like.

The control unit 200 generates image location information based on a second detection signal input from the input unit 400. In the example shown in FIG. 4, the arrangement of the display apparatuses 10 is two vertical and two horizontal. Looking at the display unit 300 on each display, a user operates the input unit 400 to select the location at which each of the display apparatuses 10 is placed. The location at which it is placed is, as shown in FIG. 4, any one of the four positions (1, 1), (1, 2), (2, 1), and (2, 2). The control unit 200 determines an identification information ID for each of the display apparatuses 10 according to the generated image location information, according to the second detection signal input from the input unit 400. In the example shown in FIG. 6, the identification information ID of the display apparatus 10a is 1, and the identification information ID of the display apparatus 10b is 2. The identification information ID of the display apparatus 10c is 3, and the identification information ID of the display apparatus 10d is 4.

The control unit 200 reads a reference point that is stored in the storage unit 500 associated with the location of the selected display apparatus 10 and the determined identification information ID. The control unit 200 calculates positional information correction values using the reference point read and the reference point of the display apparatus 10 connected as a subsequent stage of the own apparatus. The calculation of the positional information correction values will be described later. The control unit 200 calculates positional information of the selected position based on the first detection signal output by the detection unit 100. The control unit 200 outputs the calculated positional information to the outside via the communication unit 250.

The control unit 200 corrects positional information input from another display apparatus 10 via the communication unit 250, using the positional information calculated, and outputs the corrected positional information to the outside.

Furthermore, the control unit 200 instructs the display unit 300 to display the image information input from the outside.

The display unit 300 displays image information under the control of the control unit 200. The display unit 300 is for example a liquid crystal panel. The display unit 300 is constituted by including a back light apparatus and the like. The resolution of the display unit 300 is 1920 pixels in the longer direction, and 1080 pixels in the shorter direction.

The input unit 400 detects an operation by a user, and outputs a second detection signal, being the detected result, to the control unit 200. The input unit 400 is for example a button switch. The input unit 400 is used to select the arrangement of the display apparatuses 10 and the location of each of the display apparatuses 10, as shown in FIG. 4. A touch panel in the detection unit 100 may also serve as the input unit 400. In the case of the arrangement shown in FIG. 4, the user selects the arrangement two vertical and two horizontal with respect to the display apparatuses 10 using the input unit 400.

A plurality of identification information IDs and the coordinates of reference points to be described later are stored in the storage unit 500. A reference point is a point on the display unit 300 determined in advance. The reference point may be for example a point at the top left of the display unit 300.

The control apparatus 20 is connected to the display apparatus 10a by a connection cable. The connection cable is for example a USB (Universal Serial Bus) cable. The connection between the control apparatus 20 and the display apparatus 10a may be wireless. The control apparatus 20 obtains screen arrangement information of the display apparatuses 10a to 10d and the identification information IDs of the display apparatuses 10a to 10d, from the display apparatus 10a via the communication unit 250a.

The control apparatus 20 divides the data of the image 600 into four as shown in FIG. 5, and generates four images 601 to 604. The control apparatus 20 distributes video signals of the images 601 to 604 with respective identification information IDs attached, to each of the display apparatuses 10a to 10d. The control apparatus 20 performs predetermined processing based on the positional information input from the display apparatus 10a. The predetermined processing means processing such as starting an application to reproduce animation, reproducing a still picture, reproducing sound, and the like.

Next is a description of the display apparatus 10a.

The display apparatus 10a is connected with the display apparatus 10b by a connection cable. The connection cable is for example a USB cable. The connection between the display apparatuses 10 may be wireless.

The control unit 200a of the display apparatus 10a outputs image arrangement information to the control apparatus 20 via the communication unit 250 and the connection cable. The screen arrangement information is for example information indicating the arrangement two vertical and two horizontal. A video signal output by the control apparatus 20 is input to the display apparatus 10a via the communication unit 250a. The control unit 200a extracts data of the image 601, with 1 being attached as the identification information ID, from the input video signal, and displays the extracted image 601 on the display unit 300a. The control unit 200a outputs the input video signal to the display apparatus 10b. The control unit 200a reads the coordinates (Xa, Ya) of the reference point of the display apparatus 10a from the storage unit 500a according to the image arrangement information and the identification information ID=1.

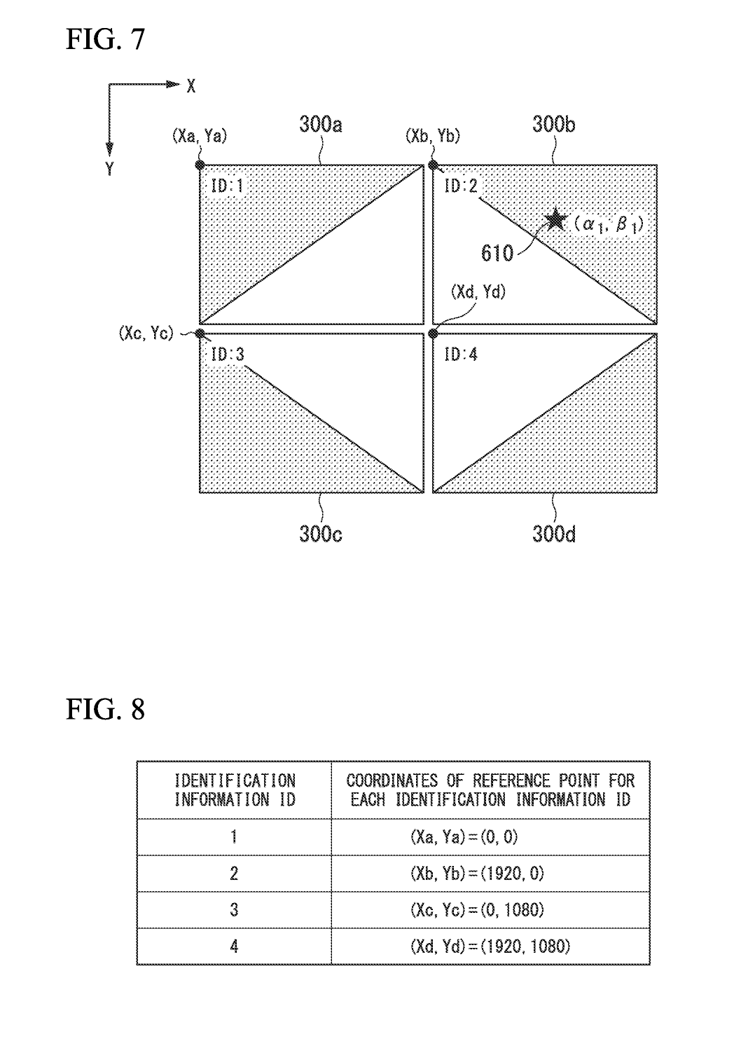

Here is a description of an example of a reference point using FIG. 7.

FIG. 7 is a diagram for explaining a reference point and a position selected according to the present exemplary embodiment. In FIG. 7, the horizontal direction of the paper is designated the X direction, and the vertical direction of the paper is designated the Y direction. In the present exemplary embodiment, as shown in FIG. 7, the upper left corner of the display unit 300 of each of the display apparatuses 10 is designated as a reference point. The reference point is based on the resolution of the display unit 300 of each of the display apparatuses 10 and the location of the display apparatus 10. The coordinates of the reference point of the display unit 300a are (Xa, Ya), and the coordinates of the reference point of the display unit 300b are (Xb, Yb). Moreover, the coordinates of the reference point of the display unit 300c are (Xc, Yc), and the coordinates of the reference point of the display unit 300d are (Xd, Yd). Furthermore, in FIG. 7, the point 610 shown by a star on the display unit 300b indicates a position selected on the display unit 300b by a user using a finger or the like. The coordinates of the position selected by the user are (α₁, β₁).

Returning to FIG. 6, the description of the display apparatus 10a will be continued.

In the case where the user makes a selection on the display unit 300a, the control unit 200a calculates positional information of the selected position based on a first detection signal output by the detection unit 100a. The control unit 200a outputs the calculated positional information to the control apparatus 20 via the communication unit 250a and the cable.

In the case where the user makes a selection on any of the display units among the display units 300b, 300c, and 300d, the control unit 200a obtains the positional information and the information ID input from the display apparatus 10b via the communication unit 250a. The control unit 200a reads the coordinates of the reference point associated with the obtained identification information ID from the storage unit 500a. The control unit 200a calculates positional correction information values using the reference point read and the reference point of the own apparatus. The control unit 200a corrects the obtained positional information using the calculated positional information correction values, and outputs the corrected positional information to the control apparatus 20 via the communication unit 250 and the cable. The correction of the positional information will be described later.

Next is a description of the control unit 200b of the display apparatus 10b. A video signal output by the display apparatus 10a is input to the display apparatus 10b via the communication unit 250b. The control unit 200b extracts data of the image 602 with 2 attached as the identification information ID, from the input video signal, and displays the extracted image 602 on the display unit 300b. The control unit 200b outputs the input video signal to the display apparatus 10c. The control unit 200b reads the coordinates (Xb, Yb) of the reference point of the display apparatus 10b according to the generated image location information.

In the case where the user makes a selection on the display unit 300b, the control unit 200b calculates positional information of the selected position based on the first detection signal output by the detection unit 100b. The control unit 200b outputs the identification information ID and the calculated positional information to the display apparatus 10a via the communication unit 250b and the cable.

In the case where the user makes a selection on the display unit 300c or the display unit 300d, the control unit 200b obtains the positional information and the identification information ID input from the display apparatus 10c via the communication unit 250b. The control unit 200b reads the coordinates of the reference point associated with the obtained identification information ID from the storage unit 500b. The control unit 200b calculates positional correction information values using the coordinates of the reference point read and the coordinates of the reference point of the own apparatus. The control unit 200b corrects the obtained positional information using the calculated positional information correction values, and outputs the identification information ID of the own apparatus and the corrected positional information to the display apparatus 10a via the communication unit 250b and the cable.

Next is a description of the control unit 200c of the display apparatus 10c.

A video signal output by the display apparatus 10b is input to the display apparatus 10c via the communication unit 250c. The control unit 200c extracts data of the image 603 with 3 attached as the identification information ID, from the input video signal, and displays the extracted image 603 on the display unit 300c. The control unit 200c outputs the input video signal to the display apparatus 10d. The control unit 200c reads the coordinates (Xc, Yc) of the reference point of the display apparatus 10c from the storage unit 500c according to the generated image location information.

In the case where the user makes a selection on the display unit 300c, the control unit 200c calculates positional information of the selected position based on the first detection signal output by the detection unit 100c. The control unit 200c outputs the identification information ID and the calculated positional information to the display apparatus 10b via the communication unit 250c and the cable.

In the case where the user makes a selection on the display unit 300d, the control unit 200c obtains the positional information and the identification information ID input from the control unit 200d. The control unit 200c reads the coordinates of the reference point associated with the obtained identification information ID from the storage unit 500c. The control unit 200c calculates positional correction information values using the coordinates of the reference point read and the coordinates of the reference point of the own apparatus. The control unit 200c corrects the obtained positional information using the calculated positional information correction values, and outputs the identification information ID of the own apparatus and the corrected positional information to the display apparatus 10b via the communication unit 250c and the cable.

Next is a description of the control unit 200d of the display apparatus 10d.

A video signal output by the display apparatus 10c is input to the display apparatus 10d via the communication unit 250d. The control unit 200d extracts data of the image 604 with 4 attached as the identification information ID from the image data input from the input video signal, and displays the extracted image 604 on the display unit 300d. The control unit 200d reads the coordinates (Xd, Yd) of the reference point of the display apparatus 10d based on the generated image location information.

In the case where the user makes a selection on the display unit 300d, the control unit 200d calculates positional information of the selected position based on the first detection signal output by the detection unit 100c. The control unit 200d outputs the identification information ID and the calculated positional information to the display apparatus 10c via the communication unit 250d and the cable.

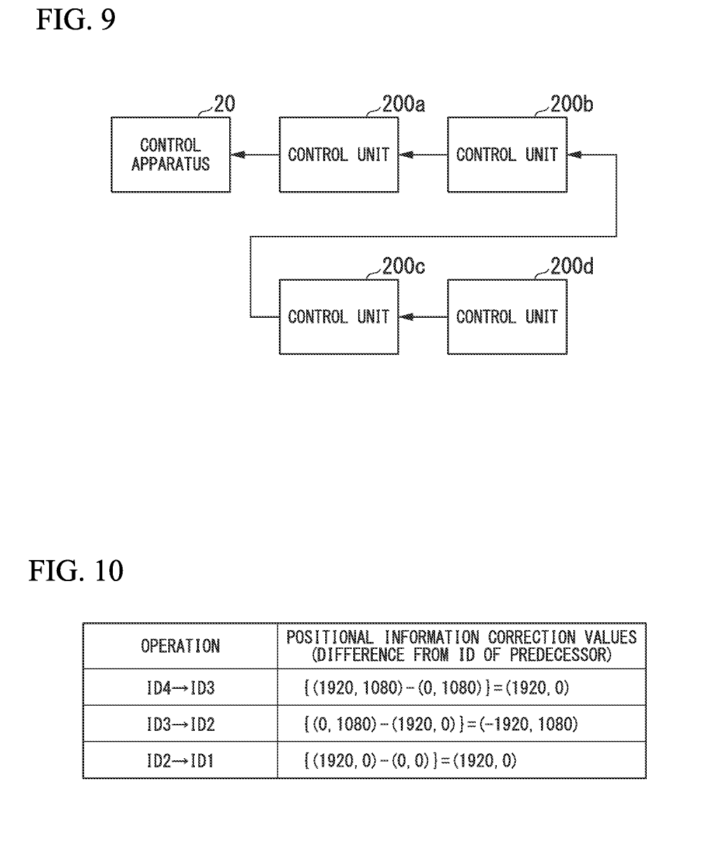

Next is a description of the correction of positional information that the control unit 200 of each of the display apparatuses 10 performs. FIG. 8 is a diagram for explaining reference points stored in a storage unit 500 according to the present exemplary embodiment. FIG. 9 is a diagram for explaining the flow of positional information according to the present exemplary embodiment. In FIG. 9, in order for explaining the flow of data, only the control units 200 from the display apparatuses 10 are extracted for illustration.

As shown in FIG. 8, identification information IDs and the coordinates of the reference points for each identification information ID are associated and stored in the storage unit 500. The example shown in FIG. 8 is an example of the case where the arrangement of the display apparatus 10 is two vertical and two horizontal, and the resolution in the X direction×Y direction of the display unit 300 of each of the display apparatuses 10 is 1920 pixels×1080 pixels.

In the storage unit 500, the identification information ID 1 and the coordinates of the reference points (0, 0) are associated and stored, and the identification information ID 3 and the coordinates of the reference points (1920, 0) are associated and stored. Furthermore, in the storage unit 500, the identification information ID 3 and the coordinates of the reference points (0, 1080) are associated and stored, and the identification information ID 4 and the coordinates of the reference points (1920, 1080) are associated and stored.

Next is a description of the flow of positional information using FIG. 9. In FIG. 9, the communication unit 250 of each of the display apparatuses 10 is omitted. The control unit 200 of each of the display apparatuses 10 performs transmission and reception with another display apparatus 10 and the control apparatus 20 via the communication unit 250.

(I) The Case where the User Makes a Selection on the Display Unit 300a of the Display Apparatus 10a

The control unit 200a outputs the detected positional information to the control apparatus 20.

(II) The Case where the User Makes a Selection on the Display Unit 300b of the Display Apparatus 10b

The control unit 200b outputs the identification information ID of the own apparatus and the detected positional information to the control unit 200a. Next, the control unit 200a corrects the positional information input from the control unit 200b using the calculated positional information correction values, and outputs the corrected positional information to the control apparatus 20.

(III) The Case where the User Makes a Selection on the Display Unit 300c of the Display Apparatus 10c

The control unit 200c outputs the identification information ID of the own apparatus and the detected positional information to the control unit 200b. Next, the control unit 200b corrects the positional information input from the control unit 200c using the calculated positional information correction values, and outputs the identification information ID of the own apparatus and the corrected positional information to the control unit 200a. Next, the control unit 200a corrects the positional information input from the control unit 200b using the calculated positional information correction values, and outputs the corrected positional information to the control apparatus 20.

(IV) The Case where the User Makes a Selection on the Display Unit 300d of the Display Apparatus 10d

The control unit 200d outputs the identification information ID of the own apparatus and the detected positional information to the control unit 200c. Next, the control unit 200c corrects the positional information input from the control unit 200d using the calculated positional information correction values, and outputs the identification information ID of the own apparatus and the corrected positional information to the control unit 200b. Next, the control unit 200b corrects the positional information input from the control unit 200c using the calculated positional information correction values, and outputs the identification information ID of the own apparatus and the corrected positional information to the control unit 200a. Next, the control unit 200a corrects the positional information input from the control unit 200b using the calculated positional information correction values, and outputs the corrected positional information to the control apparatus 20.

FIG. 10 is a diagram for explaining an example of positional information correction values in the control unit 200 of each of the display apparatuses 10 according to the present exemplary embodiment.

As shown in FIG. 10, the control unit 200c subtracts the reference point (0, 1080) of the display apparatus 10c from the reference point (1920, 1080) of the display apparatus 10d, and corrects the positional information using the subtracted values (1920, 0) as the positional information correction values.

The control unit 200b subtracts the reference point (1920, 0) of the display apparatus 10b from the reference point (0, 1080) of the display apparatus 10c, and corrects the positional information using the subtracted values (−1920, 1080) as the positional information correction values.

The control unit 200a subtracts the reference point (0, 0) of the display apparatus 10a from the reference point (1920, 0) of the display apparatus 10b, and corrects the positional information using the subtracted values (1920, 0) as the positional information correction values. These positional information correction values may be stored in the storage unit 500 in advance in association with the identification information ID for each resolution of the display apparatus 10.

Each control unit 200 corrects the positional information transmitted from another display apparatus 10 using the abovementioned positional information correction values. Here is a description of the case where a position (α₁, β₁) on the display unit 300b is selected as shown in FIG. 7. In this case, the control unit 200b outputs positional information indicating the identification information ID of the own apparatus and the detected position (α₁, β₁) to the control unit 200a.

The control unit 200a corrects the positional information (α₁, β₁) input from the control unit 200b using the calculated positional information correction values (1920, 0) as shown in the following equation (1).

Position after correction=(α₁+1920,β₁+0)=(1920+α₁,β₁) (1)

The control unit 200a outputs the identification information ID of the own apparatus and the positional information indicating the position after correction (1920+α₁, β₁) to the control apparatus 20.

Another example will describe the case in which the position (α₂, β₂) on the display unit 300d is selected. In this case, the control unit 200d outputs the identification information ID of the own apparatus and the positional information indicating the detected positional information (α₂, β₂) to the control unit 200c.

The control unit 200c corrects the positional information (α₂, β₂) input from the control unit 200d using the calculated positional information correction values (1920, 0) as shown in the following equation (2).

Position after correction=(α₂+1920,β₂+0)=(1920+α₂,β₂) (2)

The control unit 200c outputs the identification information ID of the own apparatus and the positional information indicating the position after correction (1920+α₂, β₂) to the control unit 200b.

The control unit 200b corrects the positional information (1920+α₂, β₂) input from the control unit 200c using the calculated positional information correction values (−1920, 1080) as shown in the following equation (3).

Position after correction=(1920+α₂−1920,β₂+1080)=(α₂,β₂+1080) (3)

The control unit 200b outputs the identification information ID of the own apparatus and the positional information indicating the position after correction (α₂, 1080+β₂) to the control unit 200a.

The control unit 200a corrects the positional information (α₂, 1080+β₂) input from the control unit 200b using the calculated positional information correction values (1920, 0) as shown in the following equation (4).

$$\begin{matrix}Position after correction = ( {α}_{2} + 1920 , 1080 + {β}_{2} + 0 ) \\ = ( 1920 + {α}_{1} , 1080 + {β}_{1} )\end{matrix} \qquad ( 4 )$$

The control unit 200a outputs the positional information indicating the position after correction (1920+α₂, 1080+β₂) to the control apparatus 20 via the communication unit 250a.

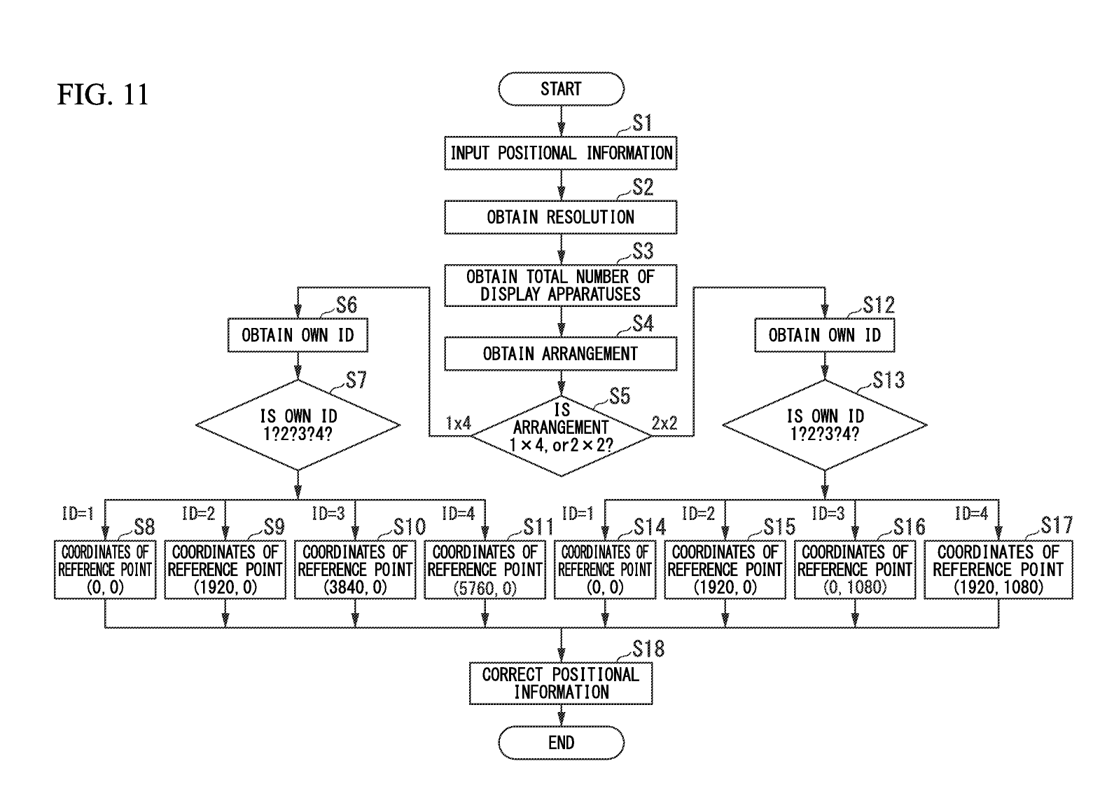

FIG. 11 is a flow chart of a procedure of the determination of a reference point, and positional information correction, performed by the control unit of each display apparatus according to the present exemplary embodiment. Using FIG. 11, cases will be described in which there are four display apparatuses 10, which are arranged with two in the vertical direction and two in the horizontal direction (2×2), and one in the vertical direction and four in the horizontal direction (1×4).

A user operates the input unit 400 of each of the display apparatuses 10 to configure the arrangement of the display apparatuses 10 and the locations of the display apparatuses 10. Then, the control unit 200 determines the identification information ID of the own apparatus 10 according to the arrangement of the display apparatuses 10, and the location of each of the display apparatuses 10. For example, in the case where the arrangement of display apparatuses is 2×2, and the location of a display apparatus 10 is (2, 2) (refer to FIG. 4), the control unit 200d determines the identification information ID to be 4.

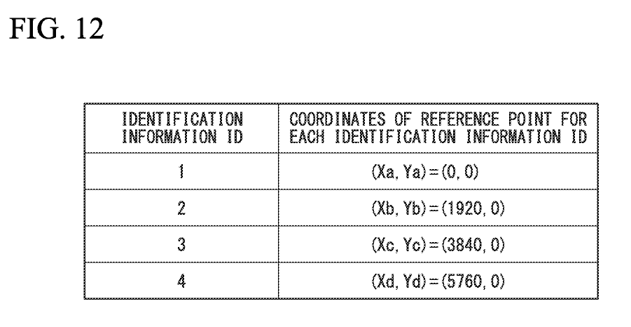

(Step S1) In the case where the detection unit 100 detects that a user has made a selection on the display unit 300, it outputs positional information indicating the selected position on the display unit 300 to the control unit 200. The control unit 200 proceeds to step S2 after step S1 is completed.
(Step S2) The control unit 200 obtains the resolution of the display unit 300. The control unit 200 proceeds to step S3 after step S2 is completed.
(Step S3) The control unit 200 obtains screen arrangement information based on the detection result detected by the input unit 400. The control unit 200 obtains the total number of display apparatuses 10 based on the obtained screen arrangement information. The control unit 200 proceeds to step S4 after step S3 is completed.
(Step S4) The control unit 200 obtains the arrangement of the display apparatuses 10 based on the obtained screen arrangement information. The arrangement of the display apparatuses 10 means, in the following description, one in the vertical direction×four in the horizontal direction (1×4), or two in the vertical direction×two in the horizontal direction (2×2). The control unit 200 proceeds to step S5 after step S4 is completed.
(Step S5) The control unit 200 determines whether the arrangement of the display apparatuses 10 obtained in step S4 is 1×4 or 2×2. In the case where the control unit 200 determines that the arrangement of the display apparatuses is 1×4 (step S5; 1×4), it proceeds to step S6. In the case where the control unit 200 determines that the arrangement of the display apparatuses is 2×2 (step S5; 2×2), it proceeds to step S12.
(Step S6) In the case where the arrangement of the display apparatuses 10 is determined to be 1×4, the control unit 200 obtains the identification information ID of the own apparatus. The control unit 200 proceeds to step S7 after step S6 is completed.
(Step S7) The control unit 200 determines whether the identification information ID obtained in step S7 is 1, 2, 3, or 4. In the case where the control unit 200 determines that the identification information ID is 1 (step S7; ID=1), it proceeds to step S8, and in the case where it determines that the identification information ID is 2 (step S7; ID=2), it proceeds to step S9. Furthermore, in the case where the control unit 200 determines that the identification information ID is 3 (step S7; ID=3), it proceeds to step S10, and in the case where it determines that the identification information ID is 4 (step S7; ID=4), it proceeds to step S11.
(Step S8) In the case where the identification information ID is determined to be 1, the control unit 200 reads the coordinates of the reference point (0, 0) stored in association with ID=1 from a table shown in FIG. 12 stored in the storage unit 500 in advance. The control unit 200 proceeds to step S18 after step S8 is completed.

FIG. 12 is a diagram showing a table of the reference points stored in the storage unit 500 according to the present exemplary embodiment. The table of the reference points shown in FIG. 12 is a table of the case in which the arrangement of the display apparatuses 10 is 1×4. As shown in FIG. 12, identification information IDs of the display apparatuses 10, and the coordinates of the reference points for each of the identification information IDs, are associated and stored in the storage unit 500. In the storage unit 500, the identification information ID=1 and the coordinates (Xa, Ya)=(0, 0) of the reference point are associated and stored, and the identification information ID=2 and the coordinates (Xb, Yb)=(1920, 0) of the reference point are associated and stored. Moreover, in the storage unit 500, the identification information ID=3 and the coordinates (Xc, Yc)=(3840, 0) of the reference point are associated and stored, and the identification information ID=4 and the coordinates (Xd, Yd)=(5760, 0) of the reference point are associated and stored.

Returning to FIG. 11, the description of the flow chart will be continued.

(Step S9) In the case where the identification information ID is determined to be 2, the control unit 200 reads the coordinates of the reference point (1920, 0) stored in association with ID=2 from the table shown in FIG. 12 stored in the storage unit 500. The control unit 200 proceeds to step S18 after step S9 is completed.
(Step S10) In the case where the identification information ID is determined to be 3, the control unit 200 reads the coordinates of the reference point (3840, 0) stored in association with ID=3 from the table shown in FIG. 12 stored in the storage unit 500. The control unit 200 proceeds to step S18 after step S10 is completed.
(Step S11) In the case where the identification information ID is determined to be 4, the control unit 200 reads the coordinates of the reference point (5760, 0) stored in association with ID=4 from the table shown in FIG. 12 stored in the storage unit 500. The control unit 200 proceeds to step S18 after step S11 is completed.
(Step S12) In the case where the arrangement of the display apparatuses 10 is determined to be 2×2, the control unit 200 obtains the identification information ID of the own apparatus. The control unit 200 proceeds to step S13 after step S12 is completed.
(Step S13) The control unit 200 determines whether the identification information ID obtained in step S12 is 1, 2, 3, or 4. In the case where the control unit 200 determines that the identification information ID is 1 (step S13; ID=1), it proceeds to step S14, and in the case where it determines that the identification information ID is 2 (step S13; ID=2), it proceeds to step S15. Furthermore, in the case where the control unit 200 determines that the identification information ID is 3 (step S13; ID=3), it proceeds to step S16, and in the case where it determines that the identification information ID is 4 (step S13; ID=4), it proceeds to step S17.
(Step S14) In the case where the identification information ID is determined to be 1, the control unit 200 reads the coordinates of the reference point (0, 0) stored in association with ID=1 from the table shown in FIG. 8 stored in the storage unit 500. The control unit 200 proceeds to step S18 after step S14 is completed.
(Step S15) In the case where the identification information ID is determined to be 2, the control unit 200 reads the coordinates of the reference point (1920, 0) stored in association with ID=2 from the table shown in FIG. 8 stored in the storage unit 500. The control unit 200 proceeds to step S18 after step S15 is completed.
(Step S16) In the case where the identification information ID is determined to be 3, the control unit 200 reads the coordinates of the reference point (0, 1080) stored in association with ID=3 from the table shown in FIG. 8 stored in the storage unit 500. The control unit 200 proceeds to step S18 after step S16 is completed.
(Step S17) In the case where the identification information ID is determined to be 4, the control unit 200 reads the coordinates of the reference point (192, 1080) stored in association with ID=4 from the table shown in FIG. 8 stored in the storage unit 500. The control unit 200 proceeds to step S18 after step S17 is completed.
(Step S18) The control unit 200 reads the coordinates of the reference point stored in the storage unit 50 in association with the identification information ID input from the display apparatus 10 connected as the subsequent stage of the own apparatus. Next, the control unit 200 calculates positional information correction values based on the coordinates of the reference point of the own apparatus read in step S8 to S11, and S14 to S17, and the coordinates of the reference point of the display apparatus connected as the subsequent stage of the own apparatus, which is read from the storage unit 500. The control unit 200 corrects the positional information input in step S1 using the calculated positional information correction values.

For example, in the case where the arrangement of the display apparatuses is 2×2, the control unit 200 corrects the positional information as shown in equation (2) to equation (4) using the positional information correction values shown in FIG. 10.

Then, the control unit 200a outputs the corrected positional information to the control apparatus 20.

As above, the determination of the coordinates of the reference points, and the correction processing of the positional information are completed.

As described above, in the display apparatus 10 of the present exemplary embodiment, the control unit further outputs information regarding an own location in the display system, and a resolution of the display apparatus, via the communication unit when the user selects a position on the display unit.

Moreover, a display apparatus of the present exemplary embodiment includes: a control unit which, based on at least information regarding a location in a display system that displays an image using a plurality of display apparatuses, which is at least information regarding a location of a display apparatus detected a position selected on a display unit by a user, and a resolution of the display apparatus, corrects the position detected by the display apparatus to a position with respect to the image displayed on the whole display system.

Furthermore, the display apparatus 10 of the present exemplary embodiment includes: a control unit which, based on information regarding a location in a display system that displays an image using a plurality of display apparatuses, which is at least information regarding a location of another display apparatus that detected a position selected on a display unit by a user, and a resolution of the own display apparatus, corrects the position detected by the other display apparatus to a position with respect to the image displayed on the whole display system.

Moreover, the display apparatus 10 of the present exemplary embodiment includes a display unit that displays an image, and the correction values are values indicating a relative relationship between a first reference point determined in advance in the display unit included in the own display apparatus and a second reference point indicating the same relative position as the first reference point in a display unit included in another display apparatus, and the control unit corrects a position detected by the other display apparatus using the correction values.

Furthermore, the display apparatus 10 according to the present exemplary embodiment includes a detection unit that detects a position selected on a display unit by a user. A control unit of the own display apparatus among a plurality of display apparatuses arranged in a matrix, in the case where the display unit is selected by the user, outputs to the outside positional information indicating the position detected by the detection unit, and in the case where the detected positional information is input from another display apparatus, corrects the input position using correction values calculated based on a first reference point determined in advance in the display unit included in the own display apparatus, and a second reference point indicating the same relative position as the first reference point in the display unit included in the other display apparatus, and outputs to the outside the positional information indicating the corrected position.

Using this construction, in the display apparatus 10 of the present exemplary embodiment, in the case where a plurality of display apparatuses 10 is connected, supposing that the plurality of display apparatuses 10 each having a detection unit is a large screen display apparatus having one detection unit, the selected position can be detected. As a result, in the display apparatus 10 of the present exemplary embodiment, it is possible to reduce the cost of an information terminal having a large touch panel corresponding to a large screen.

In FIG. 11, cases are described in which the arrangements are two in the vertical direction and two in the horizontal direction (2×2), and one in the vertical direction and four in the horizontal direction (1×4). However, the arrangement may be four in the vertical direction and one in the horizontal direction (4×1). In this case, the reference point of the display apparatus 10a with the ID being 1 is (0, 0), and the reference point of the display apparatus 10b with the ID being 2 is (0, 1080). Moreover, the reference point of the display apparatus 10c with the ID being 3 is (0, 2160), and the reference point of the display apparatus 10c with the ID being 4 is (0, 3240).

In the present exemplary embodiment, an example is described in which the control unit 200 outputs positional information and the identification information ID of the own apparatus to the display apparatus 10 connected to the own apparatus. However, this is not a limitation. The control unit 200 may output positional information and information indicating the reference point of the own apparatus to another display apparatus 10 connected to the own apparatus. In this case, the control unit 200 of the display apparatus 10 may calculate positional correction information values using the reference point of the own apparatus and the reference point of the other display apparatus 10 connected as the subsequent stage of the own apparatus.

Alternatively, the control unit 200 may output only positional information to the display apparatus 10 connected to the own apparatus. In this case, the control unit 200 of the display apparatus 10 may detect the reference point of the apparatus connected as the subsequent stage of the own apparatus based on the screen arrangement information and the identification information ID of the own apparatus. For example, a correction that the control unit 200b of the display apparatus 10b performs when two are connected in the vertical direction and two in the horizontal direction as shown in FIG. 4 is described. Since the identification information ID of the own apparatus is 2, the control unit 200b detects that the identification information ID of another display apparatus 10c connected as the subsequent stage of the own apparatus is 3, using the screen arrangement information. Next, the control unit 200b reads the coordinates of the reference point in association with the identification information ID=3, which is stored in the storage unit 500b. Next, the control unit 200b may calculate positional correction information values using the reference point read and the reference point of the own apparatus.

In the present exemplary embodiment, an example is described in which the reference point of each of the display apparatuses 10 is at the upper left corner of the display unit 300. However, this is not a limitation. The position of the reference point may be at the upper right corner, lower left corner, lower right corner, the center of gravity, or the like, of each display unit 300.

Moreover, in FIG. 11, a case is described in which the number of display apparatuses 10 is four. However, the number of display apparatuses 10 may be two or greater. In this case, each of n×m reference points (n and m are integers greater than or equal to one) may be stored in advance in the storage unit 500 of the display apparatus 10. Alternatively, the arrangement may be such that the control unit 200 obtains the resolution of a display apparatus 10, and calculates the reference point of the own apparatus using the resolution obtained. In this case, the control unit 200 of each display apparatus 10 corrects the position selected on the display unit 300 by a user, using positional information correction values based on the calculated reference point and the reference point of another display apparatus 10 connected as a subsequent stage of the own apparatus. Then, the control unit 200 may output the corrected positional information to the apparatus of the preceding stage to which the own apparatus is connected. For example, in FIG. 6, the apparatus of the preceding stage as viewed from the display apparatus 10d is the display apparatus 10c. Moreover, the apparatus of the preceding stage as viewed from the display apparatus 10a is the control apparatus 20.

Furthermore, in the present exemplary embodiment, an example is described in which the display apparatuses 10a to 10d are linked together in the order 10a, 10b, 10c, and 10d as shown in FIG. 9. However, this is not a limitation. Regarding the linking of the display apparatuses 10, provided they are linked together, the order of the links may vary. In this case also, the control unit 200 corrects the position selected on the display unit 300 by the user, using positional information correction values based on the reference point of the own apparatus and the reference point of another display apparatus 10 connected as the subsequent stage of the own apparatus. Then, the control unit 200 may output the corrected positional information to the apparatus of the preceding stage to which the own apparatus is connected. In FIG. 6 for example, the apparatus of the subsequent stage as viewed from the display apparatus 10c is the display apparatus 10d.

In the present exemplary embodiment, a case is described in which the resolutions of the display units 300 in the plurality of display apparatuses 10 are the same. However, this is not a limitation. The resolutions of the display units 300 may vary. In this case, the arrangement may be such that the control unit 200 determines a reference point according to the location of a display apparatus 10 in which an input unit 400 is operated for configuration, and the resolutions of the display units 300 of each of the display apparatuses 10, and outputs the resolution, the reference point determined, and the resolution of the own apparatus, to the control unit 200 of another display apparatus 10. The arrangement may be such that each display apparatus 10 calculates positional information correction values based on the reference point input and the resolution of the display apparatus 10 connected as the subsequent stage of the own apparatus, and corrects the position selected on the display unit 300 by the user, using the calculated positional information correction values.

### Third Exemplary Embodiment

In the second exemplary embodiment, an example is described where, in a case where a plurality of display apparatuses 10 are linked together, the control unit 200 of each display apparatus 10 corrects a position selected on the display unit 300 by a user, and outputs it. In the third exemplary embodiment, an example will be described in which the control unit of an arbitrary display apparatus corrects a position selected on a display unit by a user, and outputs it.

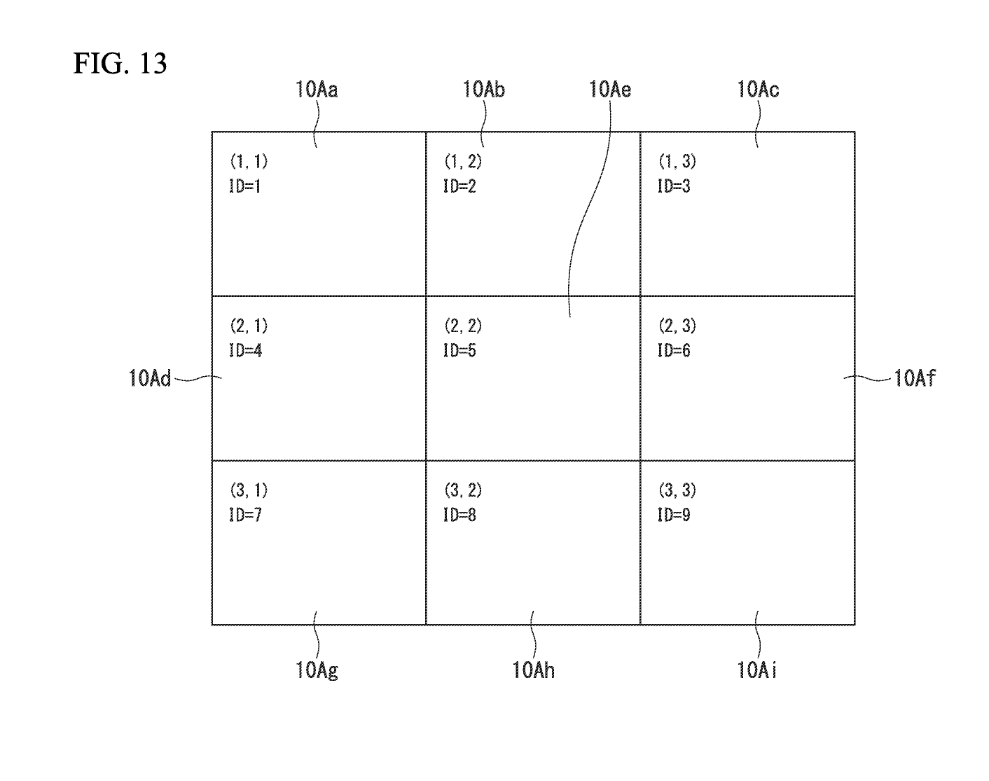

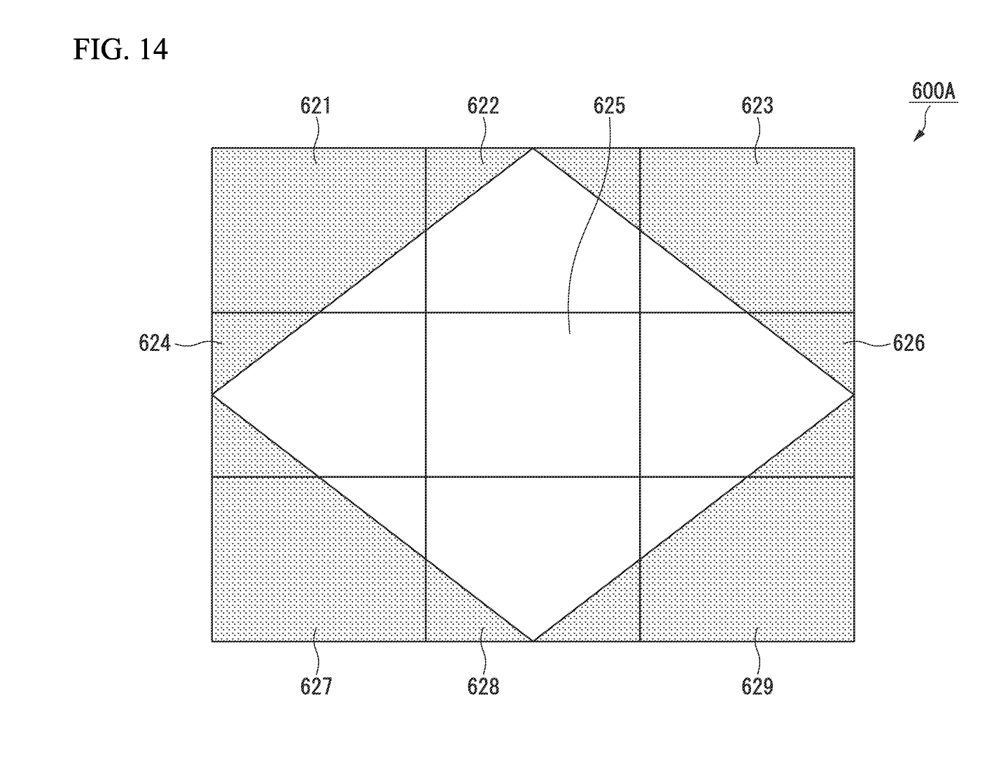

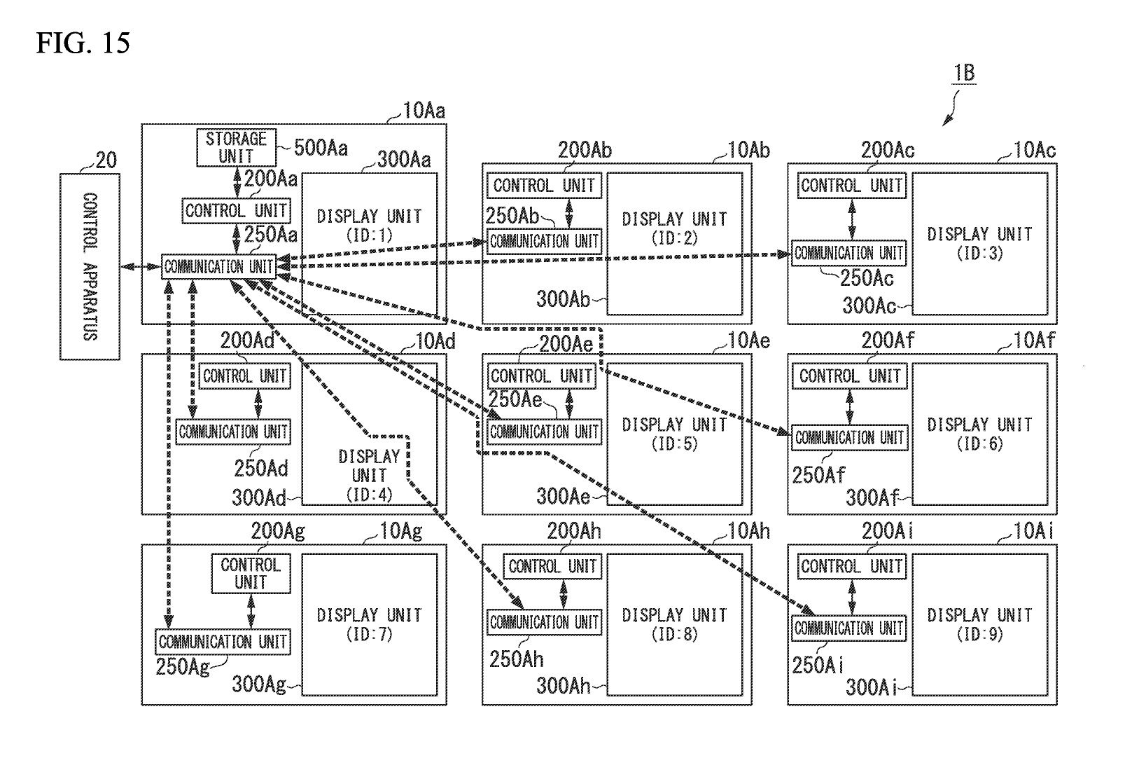

FIG. 13 is a diagram for explaining an example of an arrangement of display apparatuses 10A according to the present exemplary embodiment. FIG. 14 is a diagram for explaining an image supplied to an image display system 1B according to the present exemplary embodiment. FIG. 15 is a schematic block diagram showing an example of the structure of the image display system 1B according to the present exemplary embodiment. In the following description, as shown in FIG. 13 and FIG. 15, a case will be described in which nine display apparatuses 10Aa to 10Ai are connected such that they are arranged three in a row in the vertical direction, and three in the horizontal direction. Hereunder, the display apparatuses 10Aa to 10Ai are referred to as display apparatuses 10A as a general term. Moreover, in the present exemplary embodiment, the resolution of the display units of each of the display apparatuses 10A is 1920 pixels×1080 pixels for the purpose of description.

As shown in FIG. 13, the display apparatus 10Aa is placed at the location (1, 1), and the identification information ID is 1. The display apparatus 10Ab is placed at the location (1, 2), and the identification information ID is 2. The display apparatus 10Ac is placed at the location (1, 3), and the identification information ID is 3. The display apparatus 10Ad is placed at the location (2, 1), and the identification information ID is 4. The display apparatus 10Ae is placed at the location (2, 2), and the identification information ID is 5. The display apparatus 10Af is placed at the location (2, 3), and the identification information ID is 6. The display apparatus 10Ag is placed at the location (3, 1), and the identification information ID is 7. The display apparatus 10Ah is placed at the location (3, 2), and the identification information ID is 8. The display apparatus 10Ai is placed at the location (3, 3), and the identification information ID is 9.

An image 600A as shown in FIG. 14 is supplied from the control apparatus 20 (refer to FIG. 15) to the display apparatuses 10Aa to 10Ai. The display apparatus 10Aa displays an image 621, the display apparatus 10Ab displays an image 622, and the display apparatus 10Ac displays an image 623. The display apparatus 10Ad displays an image 624, the display apparatus 10Ae displays an image 625, and the display apparatus 10Af displays an image 626. The display apparatus 10Ag displays an image 627, the display apparatus 10Ah displays an image 628, and the display apparatus 10Ai displays an image 629.

As shown in FIG. 15, the image display system 1B includes the nine display apparatuses 10A and the control apparatus 20.

The control apparatus 20 is connected to the display apparatus 10Aa via a connection cable. The connection cable is for example a USB cable. The connection between the control apparatus 20 and the display apparatus 10Aa may be a wireless connection. The control apparatus 20 obtains screen arrangement information via the display apparatus 10Aa. The control apparatus 20 divides the data of the image 600A into nine as shown in FIG. 14, and generates nine sets of image data 621 to 629 with the identification information of each display apparatus 10A attached. The control apparatus 20 outputs the generated nine sets of image data 621 to 629 via the connection cable.

Each display apparatus 10A includes a detection unit 100, a control unit 200A, a communication unit 250A, a display unit 300A, an input unit 400, and a storage unit 500A. In FIG. 15, only the control unit 200Aa, the communication unit 250Aa, the display unit 300Aa, and the storage unit 500Aa are shown in order for explaining the operation. Furthermore, in the display apparatuses 10Ab to 10Ai, only the control units 200Ab to 200Ai, the communication units 250Ab to 250Ai, and the display units 300Aa to 300Ai are shown.

As shown in FIG. 15, in the image display system 1B, the display apparatuses 10Ab to 10Ai are connected to the display apparatus 10Aa via cables. Moreover, the display apparatus 10Aa is also connected to the control apparatus 20 via a cable. The connection among the display apparatuses 10A may be a wireless connection.

Identification information IDs and positional information correction values are stored in the storage unit 500Aa of the control unit 200Aa. The control unit 200Aa corrects input positional information using positional information correction values stored in the storage unit 500Aa in association with the input identification information ID, and outputs the corrected positional information to the control apparatus 20 via the communication unit 250Aa.

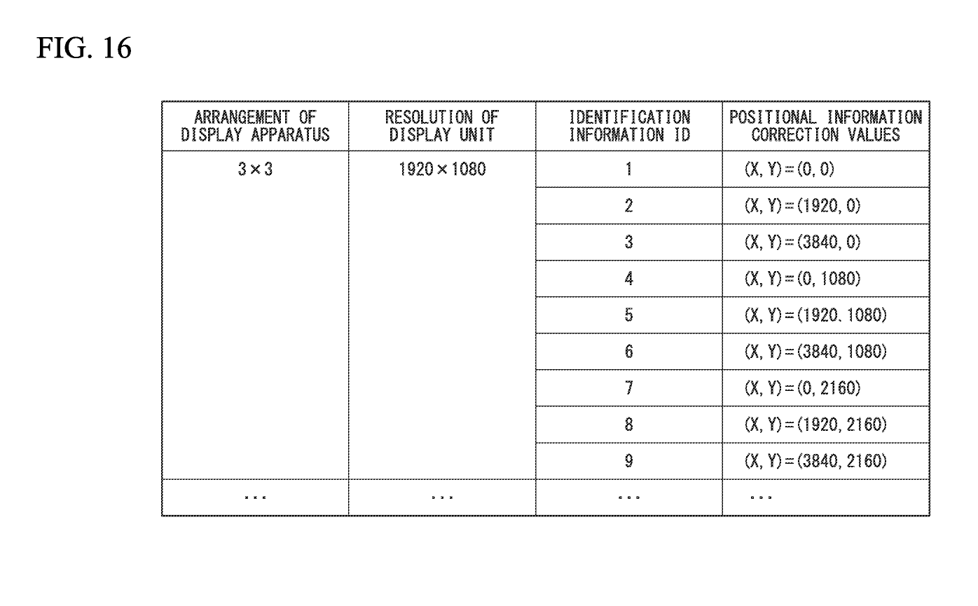

FIG. 16 is a diagram for explaining an example of information stored in the storage unit 500Aa according to the present exemplary embodiment. As shown in FIG. 16, in the storage unit 500Aa, identification information IDs and positional information correction values (X, Y) are associated and stored for the locations of each of the display apparatuses 10A and for the resolutions of each of the display units 300A. For example, identification information ID=1 and positional information correction values (X, Y)=(0, 0) are associated and stored in the storage unit 500Aa. The arrangement of the display apparatuses 10A is expressed by a set of numbers of the display apparatuses 10A arranged in the horizontal direction and in the vertical direction. The arrangement of the display apparatuses 10A may be three horizontal×three vertical, for example.

Furthermore, in the storage unit 500Aa, n×m identification information IDs and n×m positional information correction values (X, Y) are associated and stored for the arrangement of each of n×m (n and m are integers greater than or equal to one) display apparatuses 10A and for the resolutions of each of the display units 300A.

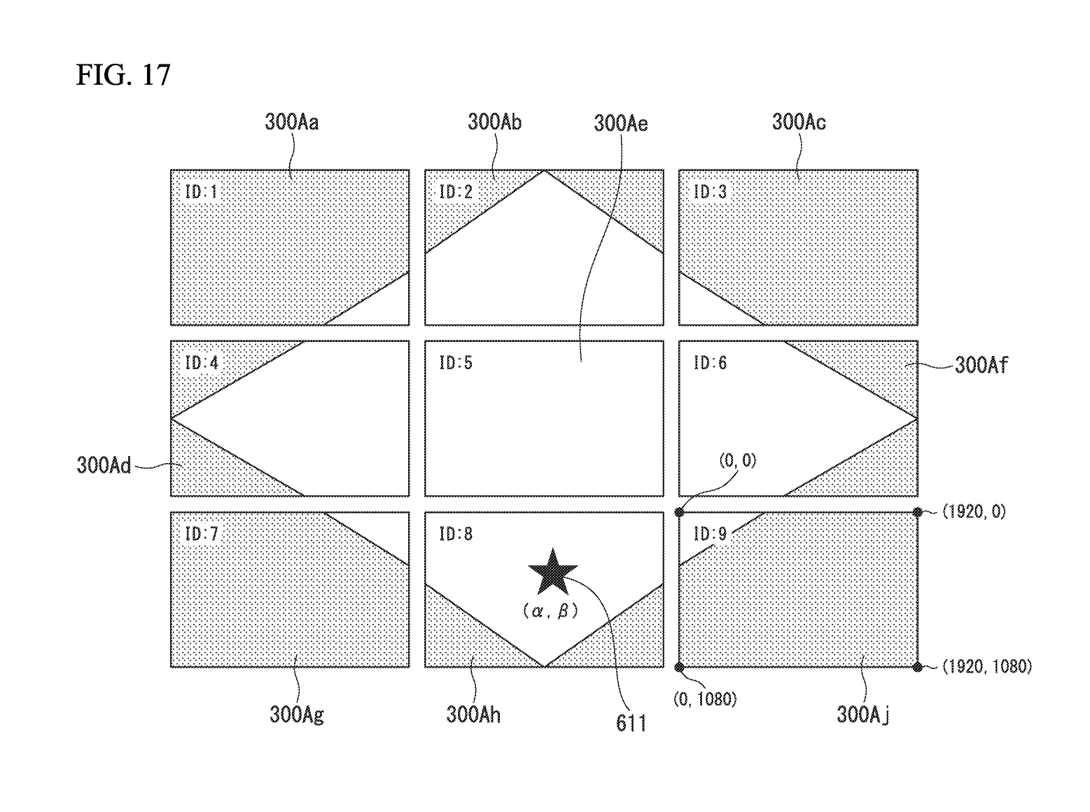

FIG. 17 is a diagram for explaining a position selected on a display unit by a user according to the present exemplary embodiment. In FIG. 17, the point 611 shown by a star on the display unit 300Ah indicates a position selected on the display unit 300Ah by the user. The coordinates of the position selected by the user are designated (α, β). Moreover, in the present exemplary embodiment, as shown in the display unit 300Ai for example, the coordinates at the upper left corner of each display unit 300A are designated (0, 0), and the coordinates at the upper right corner are (0, 1920). In the present exemplary embodiment, the coordinates at the lower left corner are (1080, 0), and the coordinates at the lower right corner are (1080, 1920).

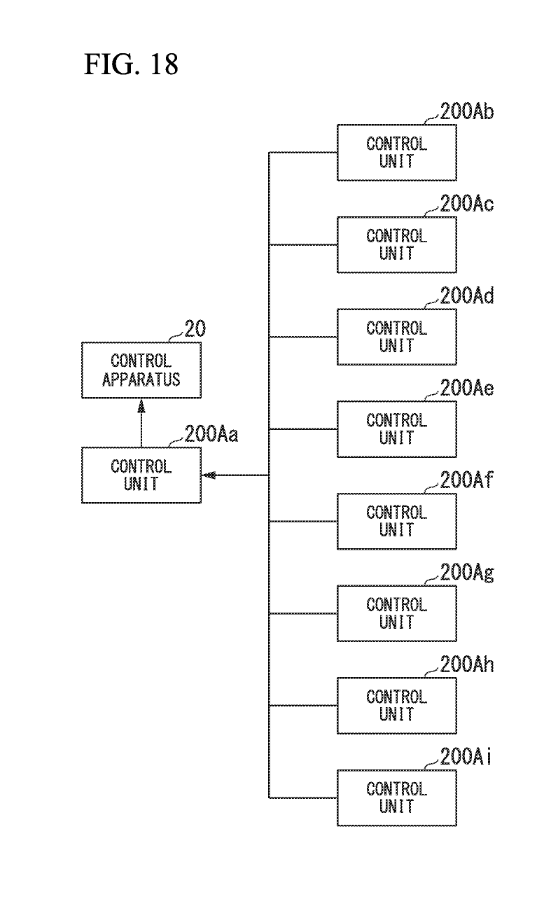

FIG. 18 is a diagram for explaining the flow of positional information according to the present exemplary embodiment. In FIG. 18, in order for explaining the flow of data, only the control unit 200A of each display apparatus 10A is shown. Furthermore, in FIG. 18, the communication unit 250A of each display apparatus 10A is omitted. The control unit 200A of each display apparatus 10A performs respective transmission and reception with another display apparatus 10A and the control apparatus 20A via the communication unit 250A.

A control unit 200Ab to 200Ai that detects that the user has selected its display unit 300A, outputs the detected positional information to the control unit 200Aa. For example, in the example shown in FIG. 17, the control unit 200Ah outputs its own identification information ID and the detected positional information to the control unit 200Aa. The control unit 200Aa reads positional information correction values stored in the storage unit 500Aa in association with the input identification information ID. The control unit 200Aa corrects the input positional information using the positional information correction values read, and outputs the corrected positional information to the control apparatus 20.

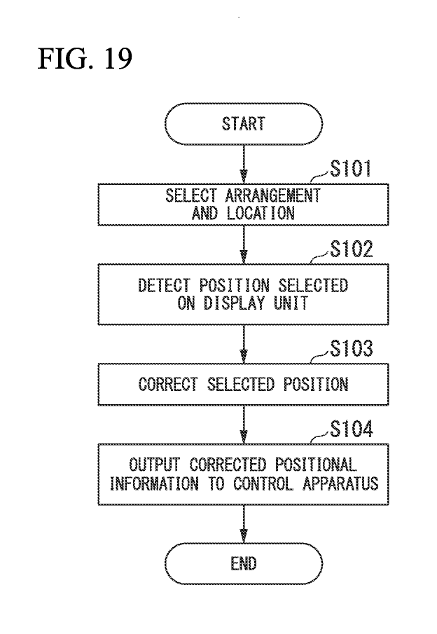

Next is a description of an example of the processing procedure. FIG. 19 is a flow chart of a procedure of reference positional information correction, performed by the image display system 1B according to the present exemplary embodiment.

(Step S101) A user operates the input unit 400A of each display apparatus 10A to configure the arrangement of the display apparatuses 10A and the location of each display apparatus 10A. Then, the control unit 200A determines identification information IDs for the own display apparatuses 10A according to the arrangement of the display apparatuses 10A, and the location of each of the display apparatuses 10A. For example, in the case where the arrangement of the display apparatuses 10A is 9×9, and the location of a display apparatus 10A is (3, 3) (refer to FIG. 13), the control unit 200Ai determines the identification information ID to be 9.
(Step S102) Regarding the detection unit 100A, the detection unit 100A detects that the user has made a selection on the display unit 300A. Next, the control unit 200A calculates positional information based on a detection signal detected by the detection unit 100A. Next, the control units 200Ab to 200Ai output identification information IDs and calculated positional information (α, β) to the control unit 200Aa via each of the communication units 250Ab to 250Ai.

For example, as shown in FIG. 17, in the case where a user selects a position (α, β) on the display unit 300Ah with the identification information ID being 8, and the location being (3, 2), the control unit 200Ah outputs the positional information (α, β) and the identification information ID=8 to the control unit 200Aa via the communication unit 250Ah.

(Step S103) The control unit 200Aa reads positional information correction values stored in the storage unit 500Aa in association with the input identification information ID. Next, the control unit 200Aa corrects the positional information (α, β) input from the control units 200Ab to 200Ai via each of the communication units 250Ab to 250Ai and the communication unit 250Aa, using the positional information correction values read from the storage unit 500Aa.

For example, the control unit 200Aa reads the positional information correction values (X, Y)=(1920, 2160) stored in the storage unit 500Aa in association with the identification information ID=8 input from the control unit 200Ah. Next, the control unit 200Aa adds the positional information (α, β) input from the control unit 200Ah to the read positional information correction values (1920, 2160) as shown in the following equation (5) to correct the positional information.

Positional information after correction=((1920+α),(1080+β)) (5)

(Step S104) The control unit 200Aa outputs the corrected positional information ((1920+a), (1080+β)) to the control apparatus 20 via the communication unit 250Aa.

As above, the correction processing of positional information is completed.

As described above, a display apparatus 10A according to the present exemplary embodiment includes a detection unit that detects a position on a display unit selected by a user. A control unit of an own display apparatus among a plurality of display apparatuses arranged in a matrix, with a first reference point being determined in advance in the display unit included in the own display apparatus, using a second reference point indicating the same relative position as the first reference point of the display unit included in another display apparatus for correction values, corrects the position input from the other display apparatus, and outputs to the outside positional information indicating the corrected position.

In this manner, the control unit 200Aa of the display apparatus 10Aa according to the present exemplary embodiment corrects the positional information selected on the display unit 300A by the user, using positional information correction values stored in the storage unit 500Aa. Then, the control unit 200Aa outputs the corrected positional information to the control apparatus 20. Accordingly, the display apparatus 10A according to the present exemplary embodiment can detect a position corresponding to a display unit of the combination of the plurality of display units 300A even in a case where display apparatuses 10A having a plurality of touch panels are connected side by side. As a result, according to the present exemplary embodiment, it is possible to realize a multi-screen using a plurality of display apparatuses 10A with a touch panel function, with a lower cost than a display apparatus having one large screen with a touch panel function.

In the present exemplary embodiment, an example is shown in which the detected positional information is corrected by the control unit 200Aa. However, another control unit 200A may correct it. In this case, the control unit 200A that has corrected the positional information may output the corrected positional information to the control apparatus 20.

Alternatively, the control unit 200A outputs the corrected positional information to the display apparatus 10Aa connected to the control apparatus 20. Then, the control unit 200Aa of the display apparatus 10Aa may output the input positional information to the control apparatus 20.

Furthermore, in the present exemplary embodiment, an example is described in which the display apparatuses 10Ab to 10Ai are connected to the display apparatus 10Aa. However this is not a limitation. Similarly to the first exemplary embodiment, the display apparatuses 10A may be linked together. In this case, the control unit 200A of the display apparatus 10A, which detected positional information indicating a position selected on the display unit 300A by a user, may output the identification information ID and the detected positional information to another display apparatus 10A of the preceding stage. The display apparatus 10A to which the identification information ID and the detected positional information are input may output the input identification information ID and the detected positional information to another display apparatus 10A of the further preceding stage. This may be performed until the display apparatus 10A connected to the control apparatus 20 receives the identification information ID and the detected positional information. Then, the display apparatus 10A connected to the control apparatus 20 may correct the input positional information using positional information correction values stored in association with the input identification information. Then, the display apparatus 10A connected to the control apparatus 20 may output the corrected positional information to the control apparatus 20.

Moreover, in the case where the display apparatuses 10A are linked together, the arrangement may be such that each control unit 200Ad corrects the detected positional information using the reference point of the own apparatus, and outputs the corrected positional information to another display apparatus 10A connected as the preceding stage of the own apparatus. For example, as shown in FIG. 6, the control unit 200Ad of the display apparatus 10Ad placed at the location with the identification information ID=4 may correct the detected positional information (α, β) using equation (5). In this case, the control unit 200Ac of the display apparatus 10Ac to which the positional information after correction is input may output it to the control unit 200Ab of the display apparatus 10Ab without correcting the positional information.

In the present exemplary embodiment, a case is described in which the resolutions of the display units 300A in the plurality of display apparatuses 10A are the same. However, this is not a limitation. The resolutions of the display units 300A may vary. In this case, a control unit 200A may output the resolutions of the display units 300A of each of the display apparatuses 10A and the resolution of the own apparatus to the control unit 200A of another display apparatus 10A. The arrangement may be such that a display apparatus 10A that outputs correction information to the control apparatus 20 calculates positional information correction values based on the input resolutions and its own resolution, and corrects the position selected on the display unit 300 by the user, using the calculated positional information correction values.

In the first exemplary embodiment, a case is described in which the position selected by the user is one point. However, this is not a limitation. The position selected by the user may be a plurality. In this case, the plurality of positions selected may be corrected by the control apparatus 20 using the positional information correction values.

Similarly, in the second and third exemplary embodiments also, the position selected by the user may be a plurality. In this case, the plurality of positions selected may be corrected by the control unit 200 (including 200A) using the positional information correction values.

Furthermore, in the first exemplary embodiment, in the case where the user selects the same position a plurality of times continuously, the display apparatus 10 that detected the positions selected by the user may transmit the number of selections at the same time to the control apparatus 20. Similarly, in the second and third exemplary embodiments also, in the case where the user selects the same position a plurality of times continuously, the display apparatus 10 that detected the positions selected by the user may transmit the number of selections at the same time to the control apparatuses 200 and 200A. In this manner, the position correction apparatus of the present exemplary embodiment can also deal with multi-touch easily.

Moreover, the position selected by a user may not be a point, it may be a region. In this case also, the control unit 200 (including 200A) may correct the selected region using positional information correction values.

In the second exemplary embodiment, the description uses a display apparatus 10 including a detection unit 100, a control unit 200, and a display unit 300 as an example. However, this is not a limitation. It may be a position correction apparatus in which the control unit 200 corrects positional information output by another display apparatus 10 as described above, and the corrected positional information is output to another display apparatus 10 that is connected as the preceding stage, or to the control apparatus 20. Similarly, in the second exemplary embodiment, the description uses a display apparatus 10A including a detection unit 100, a control unit 200A, and a display unit 300A as an example. This is not a limitation. It may be a position correction apparatus in which the control unit 200A corrects positional information output by another display apparatus 10A as described above, and the corrected positional information is output to the control apparatus 20.

In the second and third exemplary embodiments, examples are described in which when the control apparatus 20 distributes a video signal, identification IDs are attached with respect to a plurality of display apparatuses 10, and video signals are distributed to each of the display apparatuses individually. However, the control apparatus 20 may distribute to each display apparatus a video signal to display on the whole display system including a plurality of display apparatuses. In this case, each display apparatus cuts off the region that it should display from the information regarding its own location in order to display it.

The display apparatus 10 (including 10A) described in the first, the second, and the third exemplary embodiments may be for example, a portable telephone terminal having a touch screen, a tablet terminal having a touch screen, or the like.

By recording a program to realize the functions of the control apparatus 20 shown in FIG. 1, FIG. 2, and FIG. 6 of the exemplary embodiments, the control unit 200 of FIG. 6, and the control unit 200A of FIG. 15 in a computer readable recording medium, and by the program recorded in the recording medium being read by a computer system for execution, the processing of each section may be performed. “Computer system” here includes an OS and hardware such as peripheral devices. Moreover, “computer system” also includes a website provider environment (or display environment), in the case where the WWW system is used. Moreover, “computer-readable recording medium” means a flexible disk, a magneto-optical disk, a portable medium such as a ROM (Read Only Memory), a CD-ROM and the like, a USB memory that is connected via a USB (Universal Serial Bus) I/F (Interface), and a memory device such as a hard disk incorporated in a computer system. Furthermore, “computer-readable recording medium” also includes one holding a program for a certain period such as a volatile memory in a computer system, which is a server or a client. Moreover, the above-described program may be one that can realize part of the previously mentioned functions. Furthermore, it may be one that can realize the previously mentioned functions in combination with a program that has already been stored in the computer system.

### REFERENCE SYMBOLS

1, 1A, 1B Image display system
10, 10a-10d. 10A, 10Aa-10Ai Display apparatus
100, 100a-100d Detection unit
200, 200a-200d, 200Aa-200Ai Control unit
250, 250a-250d, 250Aa-250Ai Communication unit
300, 300a-300d, 300Ad, 300Aa-300Ai Display unit
400, 400a-400d Input unit
500, 500a-500d, 500Ad, 500Aa-500Ai Storage unit

1. A display apparatus that constitutes a display system that displays an image using the display apparatus and at least one other display apparatus, the display apparatus comprising:
a display unit that displays an image;
a detection unit that detects a position selected on the display unit by a user to obtain positional information;
a communication unit that communicates with a control apparatus and with the at least one apparatus; and
a control unit that performs control to communicate with the control apparatus and to communicate with the at least one display apparatus, via the communication unit,
the control unit outputting the positional information identification information of the display apparatus in the display system, via the communication unit when the user selects a position on the display unit.

2. The display apparatus according to claim 1, wherein the control unit further outputs information regarding a location of the display apparatus in the display system, and a resolution of the display apparatus, via the communication unit when the user selects a position on the display unit.

3. The display apparatus according to claim 1, wherein the control unit outputs the positional information and the resolution information for the number of times the user selects a position when the user selects a plurality of different positions on the display unit.

4. A display apparatus that constitutes a display system that displays an image using a plurality of display apparatuses including the display apparatus, the display apparatus comprising:
a control unit which corrects a position selected on a display unit by a user and detected by the display apparatus, to a position with respect to the image displayed on the whole display system, based on at least information regarding a location of the display apparatus in the display system and a resolution of the display apparatus.

5. A display apparatus comprising that constitutes a display system that displays an image using a plurality of display apparatuses including the display apparatus and another display apparatus, the display apparatus:
a control unit which corrects a position selected on a display unit by a user and detected by the other display apparatus, to a position with respect to the image displayed on the whole display system, based on at least information regarding a location of the other display apparatus in the display system and a resolution of the display apparatus.

6. The display apparatus according to claim 4, wherein the control unit corrects the position detected by the other display apparatus using a correction value based on information regarding a relative location between the display apparatus and the other display apparatus, and resolutions of the plurality of display apparatuses.

7. The display apparatus according to claim 4, wherein the control unit outputs information of the corrected position to a display apparatus connected to the display apparatus among the plurality of display apparatuses.

8. The display apparatus according to claim 4, wherein the control unit outputs information of the corrected position to a control apparatus that executes processing based on the information of the corrected position.

9. (canceled)

10. (canceled)
